(19) United States
(12) Patent Application Publication
(10) Pub. No.: US 2023/0077874 A1
(43) Pub. Date: Mar. 16, 2023

(54) METHODS AND SYSTEMS FOR DETERMINING MISSING SLOTS ASSOCIATED WITH A VOICE COMMAND FOR AN ADVANCED VOICE INTERACTION

(71) Applicant: Samsung Electronics Co., Ltd., Suwon-si (KR)

(72) Inventors: Niraj Kumar, Bengaluru (IN); Bhiman Kumar Baghel, Bengaluru (IN)

(21) Appl. No.: 17/835,387

(22) Filed: Jun. 8, 2022

Related U.S. Application Data
(63) Continuation of application No. PCT/KR2022/005907, filed on Apr. 26, 2022.

(30) Foreign Application Priority Data
Sep. 14, 2021 (IN) 202141041153

(51) Int. Cl. G10L 15/16; G10L 15/06; G10L 15/30; G10L 15/22

(52) U.S. Cl. CPC G10L 15/16; G10L 15/063; G10L 15/30; G10L 15/22; G10L 2015/223

(57) ABSTRACT

A method for determining one or more missing slots associated with a voice command for an advanced voice interaction is provided. The method includes receiving the voice command from a user. The method includes generating a textual input from the voice command received from the user. The method further includes identifying one or more intents, one or more slots and a relation between the one or more intents and the one or more slots associated with the textual input. The method also includes identifying one or more key phrases associated with the textual input and one or more domains associated with the textual input based on the one or more key phrases. The method also includes identifying one or more missing slots associated the one or more domains for the one or more intents based on fetching information associated with the one or more missing slots from a domain specific knowledge base.

### CROSS REFERENCE TO RELATED APPLICATION(S)

This application is a continuation application, claiming priority under § 365(c), of an International application No. PCT/KR2022/005907, filed on Apr. 26, 2022, which is based on and claims the benefit of an Indian patent application number 202141041153 filed on Sep. 14, 2021, in the Indian Intellectual Property Office, the disclosure of which is incorporated by reference in its entirety.

### BACKGROUND

### 1. Field

The disclosure relates to methods and system for determining missing slots. More particularly, the disclosure relates to methods and system for determining missing slots from a voice command for an advanced voice interaction.

### 2. Description of Related Art

Traditionally, single intent-based Spoken Language Understanding (STU) systems receive and execute the voice queries. Execution is based on determining a single intent associated with the voice query. In the single intent setting, the intent and slots extracted from the text. However, the existing systems are unable to identify multiple intents, relate slots with intents, find a missing slot class and determine its slot value, identify order of intents, consult user in case of confusion with missing slot candidates. This leads to a drop in quality of a user experience

A prior depicts a method for use with a computing device is provided. The method may include executing one or more programs of an intelligent digital assistant system at a processor and presenting a user interface to a user. At the processor, the method may include receiving natural language user input from the user, parsing the user input at an intent handler to determine an intent template with slots, populating the slots in the intent template with information from user input, and performing resolution on the intent template to partially resolve unresolved information. If a slot with missing slot information exists in the partially resolved intent template, a loop may be executed at the processor to fill the slots. The method may include, at the processor, determining that all required information is available and resolved and generating a rule based upon the intent template with all required information being available and resolved.

It includes a system comprising a concept of intent template as referred in FIG. 4 of the granted patent and focus on one intent at a time (which comes under ‘Action’ section). It uses loop to capture another intent, if there exist any slot information left unattended. Thus, it fails to establish the relation between intents in the multi-intent environment. Also, it fails to establish the relation between slots of different intents. For missing slot, it uses, the concept of (a) Anaphoric Expression and (b) Deictic Word. FIG. 6 of the granted patent shows slot detection process. It uses previous information, text etc., to get the indication of missing slot. But such case result in multiple user input requirements, and several times it is not possible to have such related inputs.

This is not a true Multi-Intent system, and there is no provision to re-order the execution of different intents, after getting the missing slots (if the utterance contains multiple intents, with inter intent dependent slots). This is a template-based system and uses the concept of intent template to determine intent. For missing slot identification process, it uses the concept of (a) Anaphoric Expression and (b) Deictic Word, or information from the prior utterance.

Another prior art depicts methods, systems, and computer readable storage medium related to operating an intelligent digital assistant are disclosed. A text string is obtained from a speech input received from a user. Information is derived from a communication event that occurred at the electronic device prior to receipt of the speech input. The text string is interpreted to derive a plurality of candidate interpretations of user intent. One of the candidate user intents is selected based on the information relating to the communication event.

There is a need for a solution to overcome the above-mentioned drawbacks.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to introduce a selection of concepts in a simplified format that are further described in the detailed description of the disclosure. This summary is not intended to identify key or essential disclosure of the claimed subject matter, nor is it intended for determining the scope of the claimed subject matter. In accordance with the purposes of the disclosure, the disclosure as embodied and broadly described herein, describes method and system for an on-device execution of a query based on a previous response.

Additional aspects will be set forth in part in the description which follows and, in part, will be apparent from the description, or may be learned by practice of the presented embodiments.

In accordance with an aspect of the disclosure, a method for determining one or more missing slots associated with a voice command for an advanced voice interaction is provided. The method includes receiving, by a system, the voice command from a user. The method includes generating, by the system, a textual input from the voice command received from the user. The method further includes identifying, by the system, one or more intents, one or more slots and a relation between the one or more intents and the one or more slots associated with the textual input. The method also includes identifying, by the system, one or more key phrases associated with the textual input and one or more domains associated with the textual input based on the one or more key phrases. The method also includes determining, by the system, one or more missing slots associated the one or more domains for the one or more intents based on fetching information associated with the one or more missing slots from a domain specific knowledge base.

In accordance with another aspect of the disclosure, a system for determining one or more missing slots associated with a voice command for an advanced voice interaction is provided. The system includes a memory storing at least one program and at least one processor coupled to the memory. The at least one program is configured to be executed by the at least one processor, and the at least one program including instructions for receiving, by a receiving engine, the voice command from a user. The at least one program further includes instructions for generating, by the generation engine, a textual input from the voice command received from the user. The at least one program further includes instructions for identifying, by a joint multi-tasking deep learning-model, one or more intents, one or more slots and a relation between the one or more intents and the one or more slots associated with the textual input. The at least one program further includes instructions for identifying, by a key term and domain extractor, one or more key phrases associated with the textual input and one or more domains associated with the textual input based on the one or more key phrases. The at least one program further includes instructions for determining, by a missing slot extractor, one or more missing slots associated the one or more domains for the one or more intents based on fetching information associated with the one or more missing slots from a domain specific knowledge base.

Other aspects, advantages, and salient features of the disclosure will become apparent to those skilled in the art from the following detailed description, in which, taken conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an environment comprising a system for determining one or more missing slots associated with a voice command for an advanced voice interaction, according to an embodiment of the disclosure;

FIG. 2 illustrates a schematic block diagram depicting the system for determining one or more missing slots associated with a voice command for an advanced voice interaction according to an embodiment of the disclosure;

FIGS. 3A and 3B illustrate operational flow diagrams depicting a process for determining one or more missing slots associated with a voice command for an advanced voice interaction, according to various embodiments of the disclosure;

FIGS. 4, 5, 6, and 7 illustrate use case diagrams a process for determining one or more missing slots associated with a voice command for an advanced voice interaction, according to various embodiments of the disclosure; and

FIG. 8 illustrates a block diagram depicting a method for determining one or more missing slots associated with a voice command for an advanced voice interaction according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this disclosure belongs. The system, methods, and examples provided herein are illustrative only and not intended to be limiting.

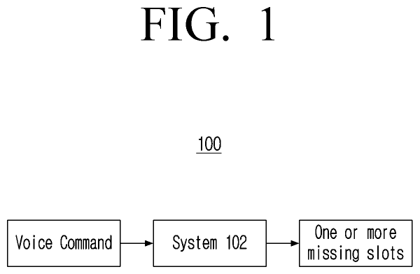

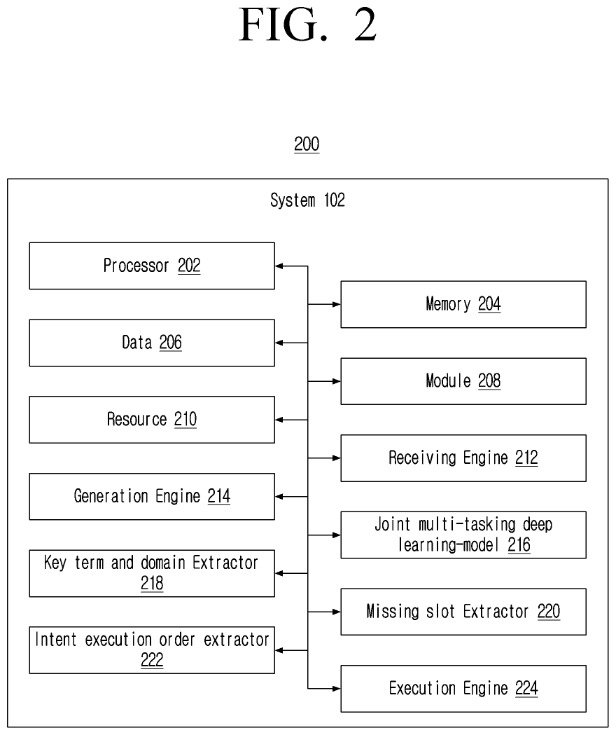

For the sake of clarity, the first digit of a reference numeral of each component of the disclosure is indicative of the Figure number, in which the corresponding component is shown. For example, reference numerals starting with digit “1” are shown at least in FIG. 1. Similarly, reference numerals starting with digit “2” are shown at least in FIG. 2, and so on and so forth.

Embodiments of the disclosure are described below in detail with reference to the accompanying drawings.

FIG. 1 illustrates an environment 100 including a system 102 for determining one or more missing slots associated with a voice command for an advanced voice interaction, according to an embodiment of the disclosure.

Referring to FIG. 1, in an embodiment, the system 102 may be one or more of a Voice Assistant (VA) and a virtual assistant. In an embodiment, the system 102 may be configured to determine the one or more slots for executing the voice command. In an embodiment, the one or more slots maybe associated with the voice command. In an embodiment, the system may be configured to determine the one or more slots based on one or more intents, one or more slots and a relation between the one or more intents and the one or more slots associated with the voice commands, one or more key phrases, and one or more domains.

Continuing with an embodiment of the disclosure, the system 102 may be configured to receive the voice command from the user. In response to receiving the voice command, the system 102 may be configured to generate a textual input associated with the voice command. Moving forward, upon generating the textual input, the system 102 may be configured to identify the one or more intents and the one or more slots associated with the textual input. To that understanding, the system 102 may be configured to identify a relation between the one or more slots and the one or more intents upon identification.

Continuing with the above embodiment, the system 102 may be configured to identify one or more key phrases associated with the textual input. Moving forward, the system 102 may be configured to identify one or more domains based associated with the textual input. In an embodiment, the one or more domains may be identified based on the identified one or more key phrases.

In response to identifying the one or more key phrases, the system 102 may be configured to identify one or more missing slots associated the one or more domains for the one or more intents. In an embodiment, the one or more missing slots may be identified based on fetching information associated with the one or more missing slots from a domain specific knowledge base.

FIG. 2 illustrates a schematic block diagram 200 depicting the system 102 for determining one or more missing slots associated with a voice command for an advanced voice interaction, according to an embodiment of disclosure.

Referring to FIG. 2, in an embodiment, the system 102 may be configured to determine the one or more missing slots by applying one or more an Artificial Intelligence (AI) technique and a deep learning technique. In an embodiment, the system 102 may be a deep learning model. In an embodiment, the system 102 may be configured to convert the vice command into a textual input. In an embodiment, the system 102 may be configured to process the textual input to determine one or more intents, one or more slots, and one or more domains associated with the voice command. In an embodiment, the system 102 may be configured to determine a relation between the one or more intents and the one or more slots. In an embodiment, the one or more intents may determine a desired outcome by the user for the voice command. In an embodiment, the one or more slots and the one or more missing slots may correspond to one or more words of the voice command. Furthermore, the system 102 may be configured to determine one or more missing slot classes associated with the voice command. To that understanding, the system 102 may be configured to determine the one or more missing slots missing from the voice command based on the one or more missing slot classes. In an embodiment, the one or more slot classes may include at least one slot amongst the one or more slots and at least one missing slot amongst the one or more missing slots. In an embodiment, the one or more slot classes may be configured to identify the one or more slots and the one or more missing sots based on the one or more intents associated with the voice command. In an embodiment, the system 102 may be configured to substitute the one or more missing slots with the voice command Continuing with the above embodiment, the system 102 may be configured to arrange the one or more intents in an order to further execute the voice command upon substituting the one or more missing slots.

In an embodiment, the system 102 includes a processor 202, a memory 204, data 206, module(s) 208, resource(s) 210, a receiving engine 212, a generation engine 214, a Joint multi-tasking deep learning-model 216, a key term and domain extractor 218, a missing slot extractor 220, an intent execution order extractor 222, and an execution engine 224. In an embodiment, the processor 202, the memory 204, the data 206, the module(s) 208, the resource(s) 210, the receiving engine 212, the generation engine 214, the joint multi-tasking deep learning-model 216, the key term and domain extractor 218, the missing slot extractor 220, the intent execution order extractor 222, and the execution engine 224 may be communicatively coupled to one another.

At least one of the plurality of modules may be implemented through an AI model. A function associated with AI may be performed through the non-volatile memory or the volatile memory, and/or the processor.

The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

A plurality of processors control the processing of the input data in accordance with a predefined operating rule or artificial intelligence (AI) model stored in the non-volatile memory or the volatile memory. The predefined operating rule or artificial intelligence model is provided through training or learning. Here, being provided through learning means that, by applying a learning technique to a plurality of learning data, a predefined operating rule or AI model of a desired characteristic is made. The learning may be performed in a device itself in which AI according to an embodiment is performed, and/or may be implemented through a separate server/system. The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (D BN), bidirectional recurrent deep neural network (BRDNN), generative adversarial networks (GAN), and deep Q-networks.

The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

According to the subject matter, in a method of an electronic device, a method for determining missing slots associated with a voice command for an advanced voice interaction may receive a speech signal, which is an analog signal, via (e.g., a microphone) and convert the speech part into computer readable text using an automatic speech recognition (ASR) model. The user's intent of utterance may be obtained by interpreting the converted text using a natural language understanding (NLU) model. The ASR model or NLU model may be an artificial intelligence model. The artificial intelligence model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Language understanding is a technique for recognizing and applying/processing human language/text and includes, e.g., natural language processing, machine translation, dialog system, question answering, or speech recognition/synthesis.

As would be appreciated, the system 102, may be understood as one or more of a hardware, a software, a logic-based program, a configurable hardware, and the like. In an example, the processor 202 may be a single processing unit or a number of units, all of which could include multiple computing units. The processor 202 may be implemented as one or more microprocessors, microcomputers, microcontrollers, digital signal processors, central processing units, processor cores, multi-core processors, multiprocessors, state machines, logic circuitries, application-specific integrated circuits, field-programmable gate arrays and/or any devices that manipulate signals based on operational instructions. Among other capabilities, the processor 202 may be configured to fetch and/or execute computer-readable instructions and/or data stored in the memory 204.

In an example, the memory 204 may include any non-transitory computer-readable medium known in the art including, for example, volatile memory, such as static random access memory (SRAM) and/or dynamic random access memory (DRAM), and/or non-volatile memory, such as read-only memory (ROM), erasable programmable ROM (EPROM), flash memory, hard disks, optical disks, and/or magnetic tapes. The memory 204 may include the data 206. In an embodiment, the memory 204 may include the prior response database storing the at least one response corresponding to the at least one previous query. Further, the prior response database may receive the response upon execution of the query.

The data 206 serves, amongst other things, as a repository for storing data processed, received, and generated by one or more of the processor 202, the memory 204, the module(s) 208, the resource(s) 210, the receiving engine 212, the generation engine 214, the joint multi-tasking deep learning-model 216, the key term and domain extractor 218, the missing slot extractor 220, the intent execution order extractor 222, and the execution engine 224. In an embodiment, the data may be a domain specific knowledge base including information associated with the one or more missing slots. In an embodiment, the domain specific knowledge base may be a semantic hypergraph mapping a binary and a non-binary relation of one or more key terms in the textual input.

The module(s) 208, amongst other things, may include routines, programs, objects, components, data structures, etc., which perform particular tasks or implement data types. The module(s) 208 may also be implemented as, signal processor(s), state machine(s), logic circuitries, and/or any other device or component that manipulate signals based on operational instructions.

Further, the module(s) 208 may be implemented in hardware, instructions executed by at least one processing unit, for e.g., processor 202, or by a combination thereof. The processing unit may be a general-purpose processor which executes instructions to cause the general-purpose processor to perform operations or, the processing unit may be dedicated to performing the required functions. In another aspect of the disclosure, the module(s) 208 may be machine-readable instructions (software) which, when executed by a processor/processing unit, may perform any of the described functionalities.

In some example embodiments, the module(s) 208 may be machine-readable instructions (software) which, when executed by a processor/processing unit, perform any of the described functionalities.

The resource(s) 210 may be physical and/or virtual components of the system 102 that provide inherent capabilities and/or contribute towards the performance of the system 102. Examples of the resource(s) 210 may include, but are not limited to, a memory (e.g., the memory 204), a power unit (e.g. a battery), a display unit, etc. The resource(s) 210 may include a power unit/battery unit, a network unit, etc., in addition to the processor 202, and the memory 204.

Continuing with the above embodiment, the receiving engine 212 may be configured to receive the voice command from a user. In an embodiment, the receiving engine 212 may be a transceiver configured to receive the voice command and forward the voice command to the generation engine 214.

To that understanding, the generation engine 214 may be configured to receive the voice command from the receiving engine 212. In response to receiving the voice command, the generation engine 214 may be configured to process the voice command. In an embodiment, the generation engine 214 may be a speech to text convertor and processing the voice command may include converting the voice command into the textual input by the generation engine 214. Furthermore, the generation engine 214 may be configured to transmit the textual input to the joint multi-tasking deep learning-model 216.

Continuing with the above embodiment, the joint multi-tasking deep learning-model 216 may be configured to receive the textual input from the generation engine 214. In an embodiment, the joint multi-tasking deep learning-model 216 may be configured to identify one or more intents associated with the voice command from the textual input. In parallel to identifying the one or more intents, the joint multi-tasking deep learning-model 216 may be configured to identify the one or more slots associated with the voice command from the textual input.

In continuation with identifying the one or more intents and the one or more slots, the joint multi-tasking deep learning-model 216 may be configured to determine a relation between the one or more intents and the one or more intents. In an embodiment, the relation identified may be utilized to further determine the one or more missing slots and execute the voice command.

Subsequent to identifying the relation between the one or more intents and the one or more slots, the key term and domain extractor 218 may be configured to process the textual input. In an embodiment, the key term and domain extractor 218 may be configured to identify one or more key phrases from the textual input associated with the voice command by processing the textual input. Upon identifying the one or more key phrases, the key term and domain extractor 218 may be configured to identify one or more domains from the textual input associated with the voice command. In an embodiment, the key term and domain extractor 218 may be configured to identify the one or more domains based on the one or more key phrases.

Continuing with the above embodiment, the missing slot extractor 220 may be configured to identify the one or more missing slots based on the one or more intents, the one or more slots, the one or more key phrases and the one or more domain classes. In an embodiment, the one or more missing slots may be identified based on fetching information related to the one or more missing slots from the domain specific knowledge base stored in the memory 204. In an embodiment, the missing slot extractor 220 may be configured to extract one or more missing slot classes for the one or more intents. In an embodiment, the one or more slots classes may be extracted based on the textual input, the one or more key phrases, and the one or more domains from the domain specific knowledge base.

In response to extracting the one or more missing slot classes, the missing slot extractor 220 may be configured to extract a missing slot class value associated with the one or more missing slot classes. In an embodiment, the missing slot class value may be extracted based on the information fetched from the domain specific knowledge base. In an embodiment, extracting the missing slot class value may be based on metadata associated with the domain specific knowledge, the one or more missing slot classes, the textual input, and a past behavior obtained a training data set generated associated with previous textual inputs. Furthermore, the missing slot extractor 220 may be configured to determine the one or more missing slots based on the slot class value associated with the one or more missing slots fetched from the domain specific knowledge base.

In an embodiment, where it is determined that the missing slot extractor 220 is unable to determine the one or more missing slots, the missing slot extractor 220 may be configured to raise one or more queries for the user based on the textual input, the one or more intents, the one or more domains. In an embodiment, being unable to identify the one or more missing slots may be based on not finding the information from the domain specific knowledge base associated with the one or more intents.

Moving forward, the receiving engine 212 may be configured to receive a response from the user for the one or more queries. In response to receiving the response from the user, the missing slot extractor 220 may be configured to identify the one or more missing slots for the textual input.

Continuing with the above embodiment, the intent execution order extractor 222 may be configured to determine an operational dependency amongst the one or more intents and the one or more missing slots. In an embodiment, operational dependency may determine an order to arrange the one or more intents for executing the textual input. In an embodiment, the operational dependency may be based on domain specific knowledge associated with the one or more intents fetched from the domain specific knowledge base. Furthermore, the intent execution order extractor 222 may be configured to re-order the one or more intents based on the operational dependency amongst the one or more intents and the one or more missing slots.

Subsequent to re-ordering the one or more intents, the execution engine 224 may be configured to execute the textual input. In an embodiment, the textual input may be executed based on the one or more intents, the order associated with the one or more intents, the one or more domains, the one or more key phrases, the one or more slots, and the one or more missing slots.

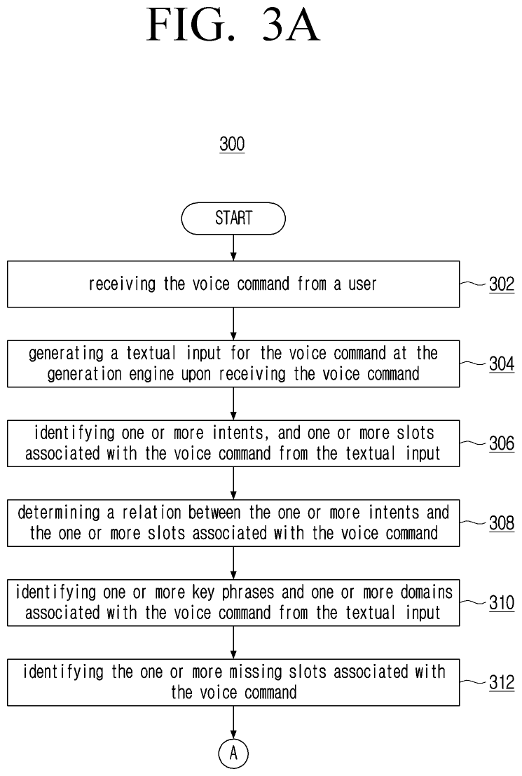

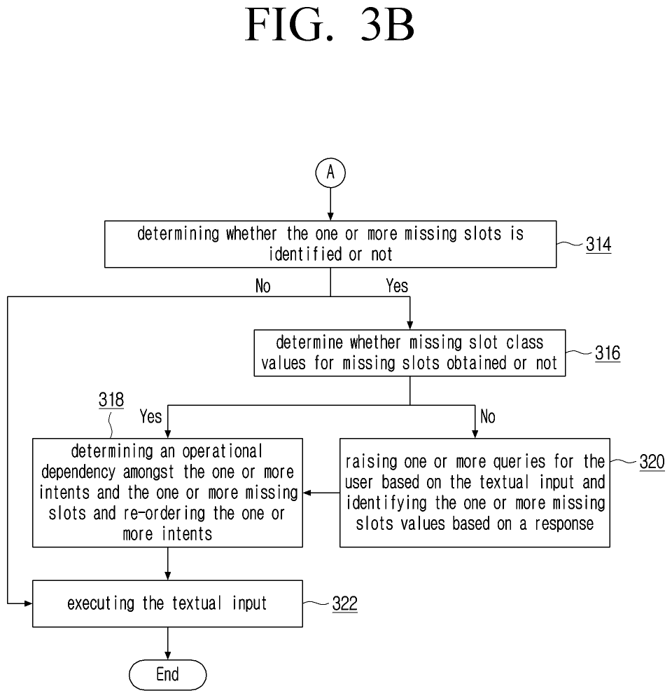

FIGS. 3A and 3B illustrate operational flow diagrams 300 depicting a process for determining one or more missing slots associated with a voice command for an advanced voice interaction, according to various embodiments of the disclosure.

In an embodiment, the one or more missing slots may be determined by the system 102 as referred in the FIG. 2 and the FIGS. 3A and 3B. In an embodiment, the one or more missing slots may be determined for executing the voice command. In an embodiment, the process may be performed through one or more of an AI technique and a deep learning technique.

Continuing with the above embodiment, the process may include receiving at operation 302 the voice command from a user. In an embodiment, the voice command may be received by the receiving engine 212 as referred in the FIG. 2. In an embodiment, the process may further include transmitting the voice command to the generation engine 214 as refereed in the FIG. 2.

In response to transmitting the voice command, the process may include generating at operation 304 a textual input for the voice command at the generation engine 214 upon receiving the voice command. In an embodiment, generating the textual input may be based on converting the voice command from a speech format to a textual format.

Moving forward, upon generation of the textual input, the process may proceed towards identifying at operation 306 one or more intents associated with the voce command from the textual input. In an embodiment, the one or more intents may determine an action to be executed as requested by the user in the voice command. In an embodiment, the process may further include identifying one or more slots from the textual input associated with the voice command. In an embodiment, the one or more slots may provide more clarity for the one or more intents such that the action may be executed. In an embodiment, the one or more intents and the one or more slots associated with the voice command may be identified by the joint multi-tasking deep learning-model 216 as referred in the FIG. 2. In an embodiment, the one or more intents may determine a desired outcome by the user for the voice command. In an embodiment, the one or more slots and the one or more missing slots may correspond to one or more words of the voice command.

In continuation with the above embodiment, the process may include determining at operation 308 a relation between the one or more intents and the one or more slots associated with the voice command. In an embodiment, the relation may be determined for the one or more intents with the corresponding one or more. In an embodiment, where it is determined that the one or more intents does not associate with the one or more slots, the process may include adding a “NULL” value relation for the one or more intents. In an embodiment, it may be assumed that the one or more intents may be associated with one of partially missing slots and fully missing slots amongst the one or more missing slots. In an embodiment, the relation between the one or more intents and the one or more slots may be determined by the joint multi-tasking deep learning-model 216.

Moving forward, subsequent to identifying the relation between the one or more intents and the one or more slots, the process may include identifying at operation 310 one or more key phrases and one or more domains associated with the voice command from the textual input. In an embodiment, the process may include processing the textual input for identifying the one or more key phrases. Further, upon successful identification of the one or more key phrases, the process may include identifying the one or more domains associated with the voice command.

In an embodiment, the one or more domains may be domain classes present to identify a domain associated with the voice command. In an embodiment, the one or more domains may be stored in the memory 204. In an embodiment, the one or more domains may be identified based on the one or more key phrases associated with the voice command. In an embodiment, the one or more key phrases and the one or more domains may be identified by the key term and domain extractor 218 as referred in the FIG. 2.

Continuing with the above embodiment, the process may include identifying at operation 312 the one or more missing slots associated with the voice command. In an embodiment, the one or more missing slots maybe identified by the missing slot extractor 220 as referred in the FIG. 2. In an embodiment, identifying the one or more missing slots may be include identifying one or more missing slot classes. In an embodiment, the one or more missing slot classes and the one or more missing slots may be identified based on the one or more intents, the one or more slots, the one or more key phrases and the one or more domain classes. In an embodiment, the process may include fetching information related to the one or more missing slots from a domain specific knowledge base stored in the memory 204. Upon fetching the information, the process may include extracting the one or more missing slot classes for the one or more intents. In an embodiment, the one or more slots classes may be extracted based on the textual input, the one or more key phrases, and the one or more domains from the domain specific knowledge base. In an embodiment, the one or more slot classes may include at least one slot amongst the one or more slots and at least one missing slot amongst the one or more missing slots. In an embodiment, the one or more slot classes may be configured to identify the one or more slots and the one or more missing sots based on the one or more intents associated with the voice command.

Subsequent to identifying the one or more missing slot classes, the process may proceed towards, extracting a missing slot class value associated with each of the one or more missing slot classes in a closed domain. In an embodiment, identifying the one or more missing slot classes from the close domain may indicate that the one or more missing slot classes is identified from the domain specific knowledge base. Moving forward, the missing slot class value may be extracted based on the information fetched from the domain specific knowledge base. In an embodiment, extracting the missing slot class value may be based on metadata associated with the domain specific knowledge, the one or more missing slot classes, the textual input, and a past behavior obtained a training data set generated associated with previous textual inputs. In an embodiment, the one or more missing slots may be identified based on the missing slot class value associated with the one or more missing slots fetched from the domain specific knowledge base.

Moving forward, the process may include determining at operation 314 whether the one or more missing slots is identified or not. In an embodiment, where it is determined that the one or more missing slots is not identified, the process may proceed towards operation 322. In an embodiment, where it is determined that the one or more missing slots is identified, the process may proceed towards operation 316.

In continuation with the above embodiment, the process may proceed towards determining at operation 316 whether the missing slot class value associated with each of the one or more missing slots is obtained or not. In an embodiment, where it is determined that the missing slot class value is obtained, the process may proceed towards operation. In an embodiment, where it is determined that the missing slot class value is not obtained, the process may proceed towards operation 320.

Continuing with the above embodiment, in response to obtaining the missing slot class value associated with the one or more missing slots, the process may include determining at operation 318 an operational dependency amongst the one or more intents and the one or more missing slots. In an embodiment, the operational dependency may determine an order to arrange the one or more intents for executing the textual input. In an embodiment, the operational dependency may be based on domain specific knowledge associated with the one or more intents fetched from the domain specific knowledge base. Furthermore, the process may include re-ordering the one or more intents based on the operational dependency amongst the one or more intents and the one or more missing slots. In an embodiment, the determining the operational dependency and re-ordering of the one or more intents may be performed by the intent execution order extractor 222 as referred in the FIG. 2.

In continuation with the above embodiment, the process may include raising at operation 320 one or more queries for the user based on the textual input, the one or more intents, the one or more domains in an open domain. In an embodiment, identifying the one or more missing slot classes from the open domain may indicate that the one or more missing slot classes is identified based on raising the one or more queries to the user. In an embodiment, the one or more queries may be raised when the one or more missing slots is not identified from the domain specific knowledge base. In an embodiment, the one or more queries may be raised by the missing slot extractor 220. Moving forward, the process may backtrack to operation 318 for identifying the one or more missing slots for the textual input based on a response received from the user corresponding to the one or more queries.

Subsequent to re-ordering the one or more intents, the process may include executing at operation 322 the textual input. In an embodiment, the textual input may be executed based on the one or more intents, the order associated with the one or more intents, the one or more domains, the one or more key phrases, the one or more slots, and the one or more missing slots. In an embodiment, the textual input may be executed by the execution engine 224 as referred in the FIG. 2.

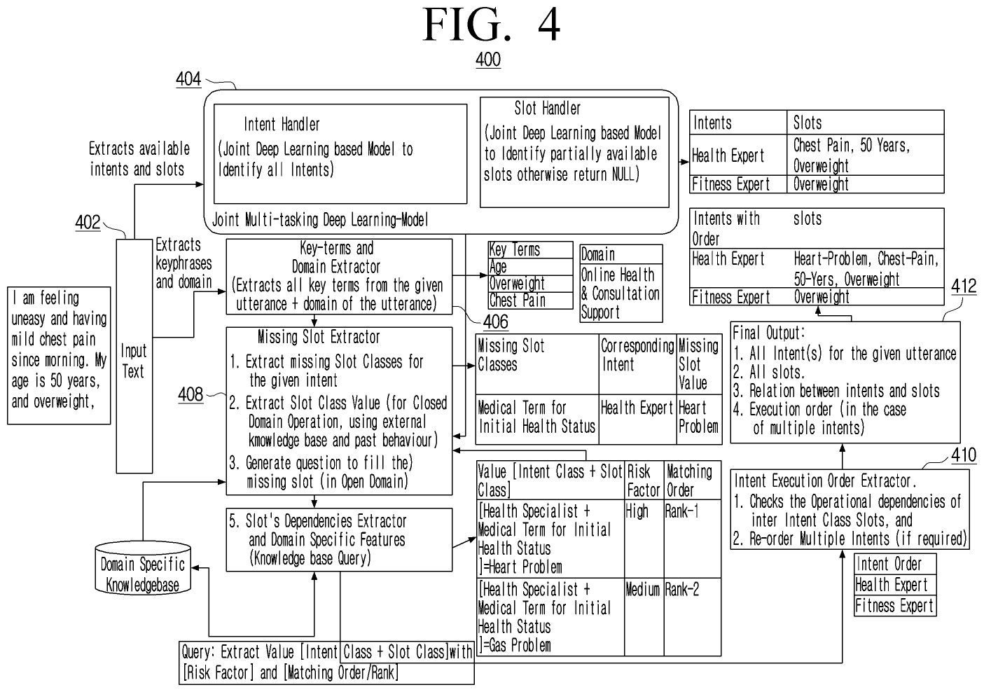

FIG. 4 illustrates a use case diagram 400 a process for determining one or more missing slots associated with a voice command for an advanced voice interaction according to an embodiment of the disclosure.

Referring to FIG. 4, in an embodiment, the process may include generating at operation 402 an input text. In an embodiment, the input text may be the textual input generated from a voice command as referred in the FIGS. 3A and 3B. In an embodiment, the textual input may be generated by the generation engine as referred in the FIG. 2. In an example, the voice command may be related to a user feeling unwell. Further, the voice command may include and age and a weight associated with the user.

Moving forward, the process may include extracting at operation 404 one or more intents and one or more slots associated with the voice command. In an embodiment, the one or more intents and the one or more slots may be extracted by the joint multi-tasking deep learning-model as referred in the FIG. 2. In an example embodiment, the one or more intents may be requiring one or more of a health expert and a fitness expert. Further, the one or more slots may include an ailment, the age, and the weight associated with the user. In an embodiment, the one or more intents and one or more slots may be identified by an intent handler and a slot handler.

Moving ahead, the process may include determining at operation 406 one or more key terms and one or more domains. In an embodiment, the one or more key terms may be determined form the textual input and the one or more domains may be determined based on the one or more key terms. In an embodiment, the one or more key terms may include the age, the weight, and the ailment such as chest pain. Furthermore, the one or more domains may include an online health and consultation support.

Further, the process may include determining at operation 408 one or more missing slots associated with the voice command by the missing slot extractor as referred in the FIG. 2. For determining the one or more missing slots, one or more missing slot classes may be extracted from a domain specific knowledge base. In an embodiment, the process may include extracting an extract slot class value from a domain specific knowledgebase. Further, the process may include determining domain specific features.

In an embodiment, where it is determined that the one or more missing slots is not determined, the process may include generating a query for a user and receive a response to determine the one or more missing slots from the user.

Moving forward, the process may include determining at operation 410 an intent execution order based on the one or more intents. In an embodiment, the intent execution order may include a “health expert” and a “fitness expert” as intents.

Continuing with the above embodiment, the process may include executing at operation 412 the one or more intents and generate a final output.

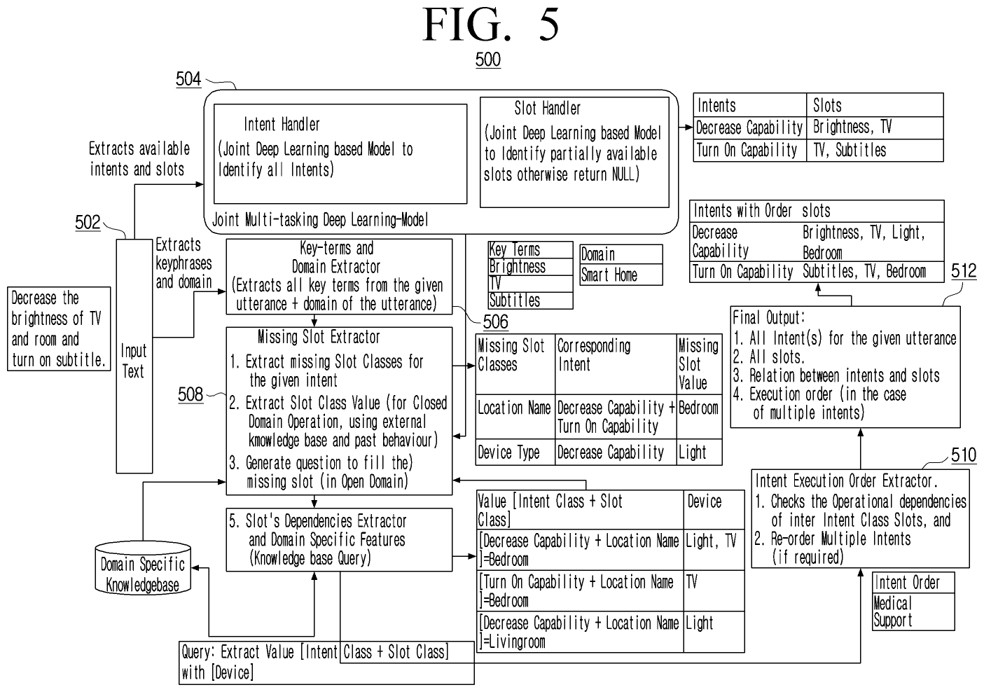

FIG. 5 illustrates a use case diagram 500 a process for determining one or more missing slots associated with a voice command for an advanced voice interaction according to an embodiment of the disclosure.

Referring to FIG. 5, in an embodiment, the process may include generating at operation 502 an input text. In an embodiment, the input text may be the textual input generated from a voice command as referred in the FIGS. 3A and 3B. In an embodiment, the voice command may be “decrease the brightness of television (TV) and room and turn on subtitle”. In an embodiment, the textual input may be generated by the generation engine as referred in the FIG. 2. In an example, the voice command may be related to a one or more of decreasing brightness of a television, a room, and turning on subtitles.

Moving forward, the process may include extracting at operation 504 one or more intents and one or more slots associated with the voice command. In an embodiment, the one or more intents and the one or more slots may be extracted by the joint multi-tasking deep learning-model as referred in the FIG. 2. In an example embodiment, the one or more intents may be a decreasing capability and a switching on capability. Further, the one or more slots may include a brightness, a television, and subtitles. In an embodiment, the one or more intents and one or more slots may be identified by an intent handler and a slot handler.

Moving ahead, the process may include determining at operation 506 one or more key terms and one or more domains. In an embodiment, the one or more key terms may be determined form the textual input and the one or more domains may be determined based on the one or more key terms. In an embodiment, the one or more key terms may include brightness, television, and subtitles. Furthermore, the one or more domains may include a smart home.

Further, the process may include determining at operation 508 one or more missing slots associated with the voice command by the missing slot extractor as referred in the FIG. 2. For determining the one or more missing slots, one or more missing slot classes may be extracted from a domain specific knowledge base. In an embodiment, the process may include extracting an extract slot class value from a domain specific knowledgebase. Further, the process may include determining domain specific features.

In an embodiment, where it is determined that the one or more missing slots is not determined, the process may include generating a query for a user and receive a response to determine the one or more missing slots from the user.

Moving forward, the process may include determining at operation 510 an intent execution order based on the one or more intents.

Continuing with the above embodiment, the process may include executing at operation 512 the one or more intents and generate a final output.

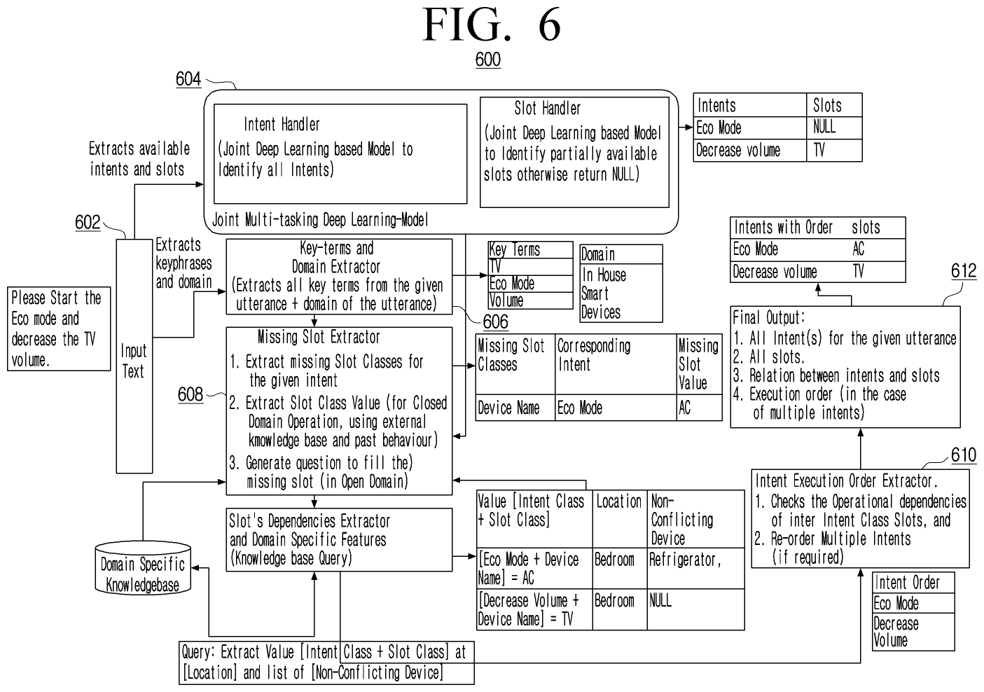

FIG. 6 illustrates a use case diagram 600 a process for determining one or more missing slots associated with a voice command for an advanced voice interaction, according to an embodiment of the disclosure.

Referring to FIG. 6, in an embodiment, the process may include generating at operation 602 an input text. In an embodiment, the input text may be the textual input generated from a voice command as referred in the FIGS. 3A and 3B. In an embodiment, the voice command may be “Please Start the Eco mode and decrease the TV volume”. In an embodiment, the textual input may be generated by the generation engine as referred in the FIG. 2. In an example, the voice command may be related to a one or more of decreasing volume of a television, and turning on an eco-mode.

Moving forward, the process may include extracting at operation 604 one or more intents and one or more slots associated with the voice command. In an embodiment, the one or more intents and the one or more slots may be extracted by the joint multi-tasking deep learning-model as referred in the FIG. 2. In an example embodiment, the one or more intents may be the eco-mode and decreasing volume. Further, the one or more slots may include a TV and null. In an embodiment, the one or more intents and one or more slots may be identified by an intent handler and a slot handler.

Moving ahead, the process may include determining at operation 606 one or more key terms and one or more domains. In an embodiment, the one or more key terms may be determined form the textual input and the one or more domains may be determined based on the one or more key terms. In an embodiment, the one or more key terms may include an eco-mode, a television, and volume. Furthermore, the one or more domains may include in-house smart devices.

Further, the process may include determining at operation 608 one or more missing slots associated with the voice command by the missing slot extractor as referred in the FIG. 2. For determining the one or more missing slots, one or more missing slot classes may be extracted from a domain specific knowledge base. In an embodiment, the process may include extracting an extract slot class value from a domain specific knowledgebase. Further, the process may include determining domain specific features.

In an embodiment, where it is determined that the one or more missing slots is not determined, the process may include generating a query for a user and receive a response to determine the one or more missing slots from the user.

Moving forward, the process may include determining at operation 610 an intent execution order based on the one or more intents.

Continuing with the above embodiment, the process may include executing at operation 612 the one or more intents and generate a final output.

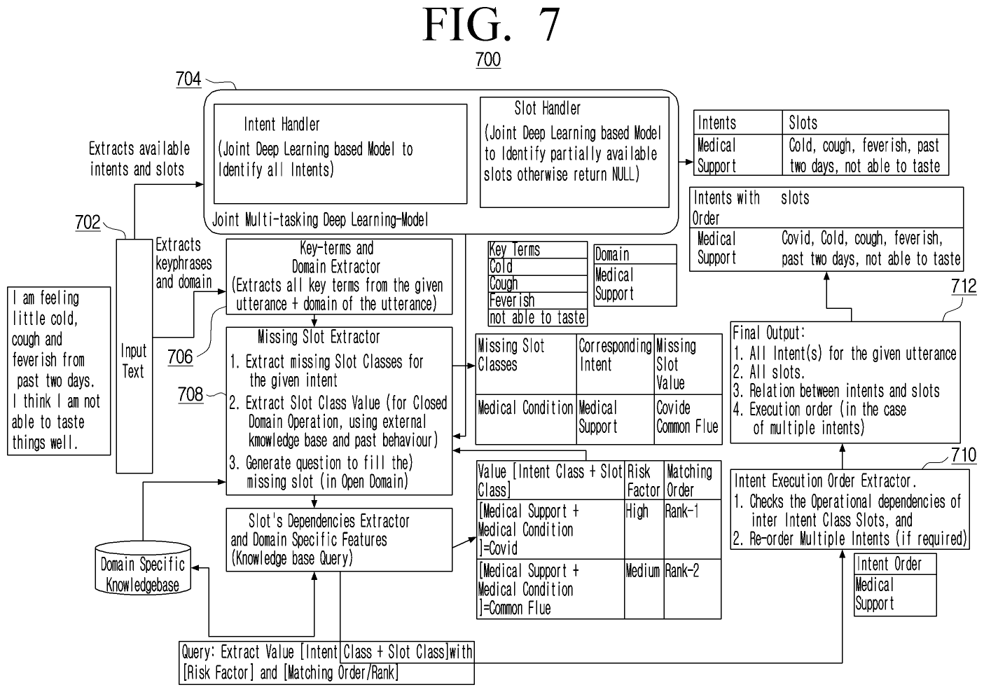

FIG. 7 illustrates a use case diagram 700 a process for determining one or more missing slots associated with a voice command for an advanced voice interaction, according to an embodiment of the disclosure.

Referring to FIG. 7, in an embodiment, the process may include generating at operation 702 an input text. In an embodiment, the input text may be the textual input generated from a voice command as referred in the FIGS. 3A and 3B. In an embodiment, the textual input may be generated by the generation engine as referred in the FIG. 2. In an embodiment, the voice command may be “I am feeling little cold, cough and feverish from past two days. I think I am not able to taste things well.” In an example, the voice command may be related to a health condition and a loss of taste.

Moving forward, the process may include extracting at operation 704 one or more intents and one or more slots associated with the voice command. In an embodiment, the one or more intents and the one or more slots may be extracted by the joint multi-tasking deep learning-model as referred in the FIG. 2. In an example embodiment, the one or more intents may be health support. Further, the one or more slots may include cold, cough, feverish, past two days, not able to taste. In an embodiment, the one or more intents and one or more slots may be identified by an intent handler and a slot handler.

Moving ahead, the process may include determining at operation 706 one or more key terms and one or more domains. In an embodiment, the one or more key terms may be determined form the textual input and the one or more domains may be determined based on the one or more key terms. In an embodiment, the one or more key terms may include an eco-mode, a television, and volume. Furthermore, the one or more domains may include in-house smart devices.

Further, the process may include determining at operation 708 one or more missing slots associated with the voice command by the missing slot extractor as referred in the FIG. 2. For determining the one or more missing slots, one or more missing slot classes may be extracted from a domain specific knowledge base. In an embodiment, the process may include extracting an extract slot class value from a domain specific knowledgebase. Further, the process may include determining domain specific features.

In an embodiment, where it is determined that the one or more missing slots is not determined, the process may include generating a query for a user and receive a response to determine the one or more missing slots from the user.

Moving forward, the process may include determining at operation 710 an intent execution order based on the one or more intents.

Continuing with the above embodiment, the process may include executing at operation 712 the one or more intents and generate a final output.

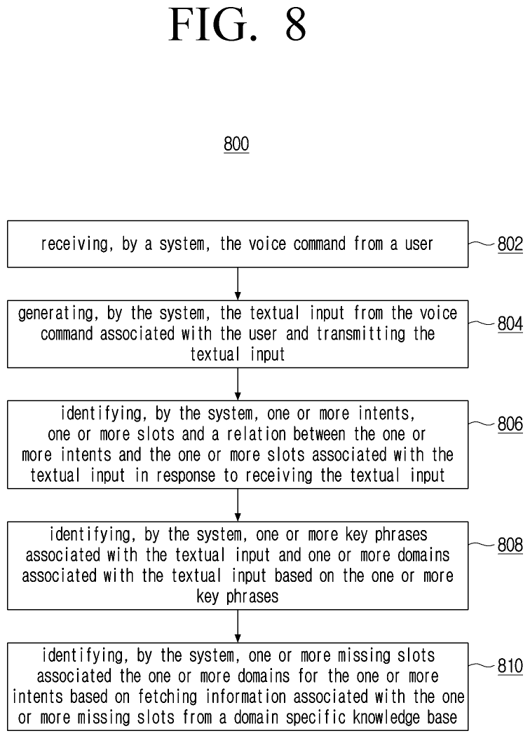

FIG. 8 illustrates a block diagram depicting a method 800 for determining one or more missing slots associated with a voice command for an advanced voice interaction, according to an embodiment of the disclosure.

The method 800 may be implemented by the system 102 using components thereof, as described above. In an embodiment, the method 800 may be executed by the receiving engine 212, the generation engine 214, the joint multi-tasking deep learning-model 216, the key term and domain extractor 218, the missing slot extractor 220, the intent execution order extractor 222, and the execution engine 224. Further, for the sake of brevity, details of the disclosure that are explained in details in the description of FIGS. 1, 2, 3A, 3B, and 4 to 7 are not explained in detail in the description of FIG. 8.

Referring to FIG. 8, at operation 802, the method 800 includes receiving, by a system, the voice command from a user.

At operation 804, the method 800 includes generating, by the system, the textual input from the voice command associated with the user and transmitting the textual input.

At operation 806, the method 800 includes identifying, by the system, one or more intents, one or more slots and a relation between the one or more intents and the one or more slots associated with the textual input in response to receiving the textual input.

At operation 808, the method 800 includes identifying, by the system, one or more key phrases associated with the textual input and one or more domains associated with the textual input based on the one or more key phrases.

At operation 810, the method 800 includes identifying, by the system, one or more missing slots associated the one or more domains for the one or more intents based on fetching information associated with the one or more missing slots from a domain specific knowledge base.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for determining one or more missing slots associated with a voice command for an advanced voice interaction, the method comprising:
receiving, by a system, the voice command from a user;
generating, by the system, a textual input from the voice command received from the user;
identifying, by the system, one or more intents, one or more slots and a relation between the one or more intents and the one or more slots associated with the textual input;
identifying, by the system, one or more key phrases associated with the textual input and one or more domains associated with the textual input based on the one or more key phrases; and
determining, by the system, one or more missing slots associated the one or more domains for the one or more intents based on fetching information associated with the one or more missing slots from a domain specific knowledge base.

2. The method as claimed in claim 1, further comprising:
raising, by the system, one or more queries for the user based on the textual input, the one or more intents, the one or more domains in response to not identifying the one or more missing slots from the domain specific knowledge base; and
identifying, by the system, the one or more missing slots for the textual input based on a response received from the user corresponding to the query.

3. The method as claimed in claim 1, further comprising:
determining, by the system, an operational dependency amongst the one or more intents and the one or more missing slots based on domain specific knowledge associated with the one or more intents fetched from the domain specific knowledge base, wherein the operational dependency determines an order to arrange the one or more intents for executing the textual input;
re-ordering, by the system, the one or more intents based on the operational dependency amongst the one or more intents and the one or more missing slots; and
executing, by the system, the textual input based on the one or more intents, the order associated with the one or more intents, the one or more domains, the one or more key phrases, the one or more slots, and the one or more missing slots.

4. The method as claimed in claim 1, wherein the identifying the one or more missing slots comprising:
extracting, by the system, one or more missing slot classes for the one or more intents based on the textual input, the one or more key phrases, and the one or more domains from the domain specific knowledge base.

5. The method as claimed in claim 4, further comprising:
extracting, by the system, a missing slot class value associated with the one or more missing slot classes based on information fetched from the domain specific knowledge base; and
determining, by the system, the one or more missing slots based on the missing slot class value associated with the one or more missing slots fetched from the domain specific knowledge base.

6. The method as claimed in claim 5, wherein extracting the missing slot class value is based on metadata associated with the domain specific knowledge base, the one or more missing slot classes, the textual input, and a past behavior obtained a training data set generated associated with previous textual inputs.

7. A system for determining one or more missing slots associated with a voice command for an advanced voice interaction, the system comprising:
a memory storing at least one program; and
at least one processor coupled to the memory,
wherein the at least one program is configured to be executed by the at least one processor, the at least one program including instructions for:
receiving, by a receiving engine, the voice command from a user,
generating, by a generation engine, a textual input from the voice command received from the user,
identifying, by a joint multi-tasking deep learning-model, one or more intents, one or more slots and a relation between the one or more intents and the one or more slots associated with the textual input,
identifying, by a key term and domain extractor, one or more key phrases associated with the textual input and one or more domains associated with the textual input based on the one or more key phrases, and
determining, by a missing slot extractor, one or more missing slots associated the one or more domains for the one or more intents based on fetching information associated with the one or more missing slots from a domain specific knowledge base.

8. The system as claimed in claim 7, wherein the at least one program further includes instructions for:
raising, by the missing slot extractor, one or more queries for the user based on the textual input, the one or more intents, the one or more domains in response to not identifying the one or more missing slots from the domain specific knowledge base; and
identifying, by the missing slot extractor, the one or more missing slots for the textual input based on a response received from the user corresponding to the query.

9. The system as claimed in claim 7, wherein the at least one program further includes instructions for:
determining, by an intent execution order extractor, an operational dependency amongst the one or more intents and the one or more missing slots based on domain specific knowledge associated with the one or more intents fetched from the domain specific knowledge base, wherein the operational dependency determines an order to arrange the one or more intents for executing the textual input;
re-ordering, by the intent execution order extractor, the one or more intents based on the operational dependency amongst the one or more intents and the one or more missing slots; and
executing, by an execution engine, the textual input based on the one or more intents, the order associated with the one or more intents, the one or more domains, the one or more key phrases, the one or more slots, and the one or more missing slots.

10. The system as claimed in claim 7, wherein the identifying the one or more missing slots comprises:
extracting, by the missing slot extractor, one or more missing slot classes for the one or more intents based on the textual input, the one or more key phrases, and the one or more domains from the domain specific knowledge base.

11. The system as claimed in claim 10, wherein the at least one program further includes instructions for:
extracting, by the missing slot extractor, a missing slot class value associated with the one or more missing slot classes based on information fetched from the domain specific knowledge base; and
determining, by the missing slot extractor, the one or more missing slots based on the missing slot class value associated with the one or more missing slots fetched from the domain specific knowledge base.

12. The system as claimed in claim 11, wherein the extracting of the missing slot class value is based on metadata associated with the domain specific knowledge base, the one or more missing slot classes, the textual input, and a past behavior obtained a training data set generated associated with previous textual inputs.
